(19) United States
(12) Patent Application Publication
(10) Pub. No.: US 2007/0245897 A1
(43) Pub. Date: Oct. 25, 2007

(54) Electron, hydrogen and oxygen conveying membranes

(75) Inventors: Charles J. Besecker, Batavia, IL (US); Mark S. Kleefisch, Plainfield, IL (US); Jane Zhang, Naperville, IL (US)

Correspondence Address: INEOS USA LLC, 3030 WARRENVILLE RD, S/650, LISLE, IL, 60532, US

(73) Assignee: Innovene USA, Lisle, IL (US)

(21) Appl. No.: 11/407,781

(22) Filed: Apr. 20, 2006

(51) Int. Cl. B01D 53/22

(52) U.S. Cl. 96/11

(57) ABSTRACT

Preparation, structure, and properties of non-homogenous solid systems, which in the form of a solid state membrane demonstrate an ability to selectively convey electrons, hydrogen and oxygen between different gaseous mixtures, and their uses, are described. Multiphasic systems of the invention comprising two or more phases bound to one another, and at least one of the bound phases demonstrates an ability to selectively convey hydrogen, another phase demonstrates an ability to selectively convey oxygen ions between different gaseous mixtures, and one or more phase demonstrates electronic conductivity.

### TECHNICAL FIELD

The present invention relates to preparation, structure, and properties of non-homogenous solid systems which in the form of a solid state membrane demonstrate an ability to selectively convey electrons, hydrogen and oxygen between different gaseous mixtures, and more particularly to multiphasic systems comprising two or more phases bound to one another. In multiphasic systems according to the present invention, at least one of the bound phases demonstrates an ability to selectively convey hydrogen, another phase demonstrates an ability to selectively convey oxygen ions between different gaseous mixtures, and one or more phase demonstrates electronic conductivity. Electron, hydrogen and oxygen conveying materials are useful in fabrication of membranes for use in chemical processes, particularly for decomposition of hydrogen-containing gases, oligomerization of hydrocarbons and for dehydrogenation of hydrocarbons, for example dehydrogenation of alkanes to produce alkenes.

### BACKGROUND OF THE INVENTION

Solid state systems and their use in membranes for facilitating various chemical reactions have been studied and used previously. Of particular interest are solid membrane materials that convey both electrons and ions with out the use of external electrodes. U.S. Pat. No. 4,330,633 issued May 18, 1982, in the name of Yoshisato et al., describes a solid electrolyte said to selectively separate oxygen from a gaseous atmosphere having a high oxygen partial pressure into a gaseous atmosphere having a low oxygen partial pressure. Patentees describe the solid electrolytes as composed of a sintered body consisting essentially of an oxide of cobalt, an oxide of at least one metal selected from strontium and lanthanum, and an oxide of at least one metal selected from bismuth and cerium.

U.S. Pat. No. 4,791,079 issued Dec. 13, 1988, in the name of Hazbun, describes a mixed ion and electron conducting catalytic ceramic membrane said to be useful in hydrocarbon oxidation or dehydrogenation processes. Patentee describes the membrane as consisting of two layers, one of which is an impervious mixed ion and electron conducting ceramic layer and the other is a porous catalyst-containing ion conducting ceramic layer. This impervious mixed ion and electron conducting ceramic membrane is further described at column 2, lines 57-62, as yttria stabilized zirconia which is doped with sufficient cerium oxide, CeO₂, or titanium oxide, TiO₂, to impart electron conducting characteristics to the ceramic.

European Patent Application 90305684.4, published on Nov. 28, 1990, under Publication No. EP 0 399 833 A1 in the name of Cable et al., describes an electrochemical reactor using solid membranes comprising; (1) a multi-phase mixture of an electronically conductive material, (2) an oxygen ion-conductive material, and/or (3) a mixed metal oxide of a perovskite structure. Reactors are described in which oxygen from oxygen-containing gas is transported through a membrane disk to any gas that consumes oxygen. Flow of gases on each side of the membrane disk in the reactor shell shown, are symmetrical flows across the disk, substantially radial outward from the center of the disk toward the wall of a cylindrical reactor shell. The gases on each side of the disk flow parallel to, and co-current with, each other.

However, a recurring problem that is common to many such compositions and membranes is that they often tend to break, fracture, and/or a undergo phase change and thereby to lose their ability to selectively separate and/or transport the desired gaseous material, after relatively short period of time under commercial conditions of operation, i.e., pressure drop across the membrane, elevated temperatures of operation, changes of temperature, temperature differentials, and the like.

Membrane compositions have been described for transport of electrons and hydrogen. Other membrane compositions have been described for conducting electrons and oxygen. Membranes composed of a single phase capable of simultaneous hydrogen and oxygen transport have been described. For example, membranes composed of a single mixed oxide for oxygen and hydrogen transport are described in an article entitled “Oxide Ion Conduction in Ytterbium-Doped Strontium Cerate” by N. Bonanos, B. Ellis and M. N. Mahmood in Solid State Ionics, vol. 28-30, pages 579-579 (1988). A single phase mixed membrane for alkane dehydrogenation is described in U.S. Pat. No. 5,821,185, U.S. Pat. No. 6,037,514 and U.S. Pat. No. 6,281,403 each in the name of in the name of James H. White, Michael Schwartz and Anthony F. Sammels and assigned to Eltron Research, Inc.

As noted by Bonanos et al., it is difficult to independently adjust the rates of oxygen and hydrogen transport in a membrane composed of a single phase. Dual phase membranes offer the potential to balance the rates of oxygen and hydrogen transport. If one phase is responsible for hydrogen transport and the other is responsible for oxygen transport, it would be possible to adjust the relative amounts of the two phases to independently adjust the rates of hydrogen and oxygen transport.

U.S. Pat. No. 6,332,964 in the name of Chieh Cheng Chen, Bavi Prasad, Terry J. Mazanec, and Charles J. Besecker, describes dual phase membranes composed of an electron conducting phase and an oxygen conducting phase, for example, a membrane where a palladium-silver alloy is the electron conducting phase and a cerium gadolinium oxide is the oxygen conducting phase.

A single membrane matrix composed of two phases that is capable of simultaneously transporting oxygen, hydrogen, and electrons has not been described in the past. Such a matrix can be formed by combining an oxygen conducting material with a material capable of transporting hydrogen whereby one or both of these materials is also an electronic conductor.

There is, therefore, a present need for improved non-homogenous solid systems, which in the form of a solid state membrane demonstrate an ability to selectively convey electrons, hydrogen and oxygen between different gaseous mixtures. Particularly desirable should be an intimate, gas-impervious, multiphasic systems comprising two or more phases bound to one another.

For example, U.S. Pat. No. 6,281,403 in the name of James H. White, Michael Schwartz and Anthony F. Sammels, describes proton and electron conducting membranes for the dehydrogenation of alkanes. One of several disadvantages of this process is the strongly reducing environment of this process, which tends to produce coke and damage these membranes. Using new materials capable of oxygen conductivity in addition to hydrogen transport and electronic conductivity could eliminate this deactivation by oxidizing carbonaceous species on the membranes.

New materials for membrane separations should beneficially exhibit greater stability when exposed to operating conditions for extended time periods. Particularly beneficially should be new materials, which form non-porous membranes that exhibit negligible vapor pressure under ambient conditions.

Furthermore, new composition should advantageously provide stable materials for membranes that are free of interfacial surfaces between a continuous phase and particles of a discontinuous phase at which surfaces leakage can occur.

A matrix that is capable of simultaneously transporting oxygen, hydrogen, and electrons could produce hydrogen gas and synthesis gas with a single membrane. Using a single membrane has numerous advantages including cost savings and operational simplicity.

It is an object of the invention to overcome one or more of the problems described above.

Other advantages of the invention will be apparent to those skilled in the art from a review of the following detailed description, taken in conjunction with the drawing and the appended claims.

### SUMMARY OF THE INVENTION

In broad aspect, the present invention includes preparation, structure, and properties of non-homogenous solid systems which in the form of a solid state membrane demonstrate an ability to selectively convey electrons, hydrogen and oxygen between different gaseous mixtures containing hydrogen, oxygen and one or more other volatile components.

In another aspect, the invention is a multiphasic composition which in the form of a solid state membrane demonstrates an ability to selectively convey electrons, hydrogen and oxygen between different gaseous mixtures, the multiphasic composition comprising two or more phases bound to one another wherein at least one of the bound phases demonstrates an ability to selectively convey hydrogen, another phase demonstrates an ability to selectively convey oxygen ions between different gaseous mixtures, and one or more of the phases demonstrates electronic conductivity. Particularly useful are multiphasic compositions of the invention, which in the form of a solid state membrane demonstrates an ability to simultaneously convey a flux of hydrogen and, counter-current thereto, a flux of oxygen.

A dense ceramic membrane permeable to hydrogen, oxygen and demonstrates electronic conductivity comprising a multiphasic composition according to the invention advantageously further comprises a continuous, dense, fine-grained, agglomerating agent which beneficially comprises material according to one of the two bound phases. In one aspect of the invention, for example, the agent comprises a mixed metal oxide that demonstrates an ability to selectively convey oxygen ions, and wherein one of the bound phases comprises a metal, alloy or mixed metal oxide that demonstrates electronic conductivity.

In another aspect, the invention is a transport membrane having an ability to selectively convey electrons, hydrogen and oxygen between different gaseous mixtures that comprises: a non-homogenous, multiphasic solid containing a first phase comprising a metal, alloy or mixed-metal oxide, and a second phase comprising a mixed metal oxide ceramic, wherein the first and second phases are bound to one another and distributed, in a physically distinguishable form, throughout the continuous, fine-grained, second phase.

In particularly useful multiphasic compositions of the invention the first phase comprises at least one metal selected from the group consisting of silver, palladium, platinum, gold, rhodium, titanium, nickel, ruthenium, tungsten, and tantalum. In another particularly useful multiphasic composition according to the invention the first phase comprises a ceramic selected from the group consisting of a praseodymium-indium oxide mixture, niobium-titanium oxide mixture, titanium oxide, nickel oxide, tungsten oxide, tantalum oxide, ceria, zirconia, magnesia, or a mixture thereof.

In particularly advantageous multiphasic compositions according to the invention the second phase comprises a mixed conducting oxide composition represented by
(A_{1-y}A′_{y})(B₁₋ₓB′_{z}B″_{x-z})O_{δ} (I)
where A is a lanthanide element, yttrium (Y), or mixture thereof, A′ is one or more alkaline earth metal; B is iron (Fe); B′ is chromium (Cr), titanium (Ti), or mixture thereof and B″ is manganese (Mn), cobalt (Co), vanadium (V), nickel (Ni), copper (Cu) or mixture thereof; and x and y are each independently selected numbers from zero to about one, and z is a number zero to x; and δ is a number determined from stoichiometry that renders the compound charge neutral.

In other multiphasic compositions according to the invention the second phase comprises a mixed conducting cerium oxide composition represented by
M′CeO_{δ} (II)
where M′ is selected from the group consisting of yttrium (Y) and elements having atomic numbers from 58 to 71 inclusive, and δ is a positive number determined from stoichiometry. In yet other multiphasic compositions according to the invention the second phase comprises a mixed conducting zirconium oxide composition represented by
M″ZrO_{δ} (III)
where M″ is selected from the group consisting of calcium (Ca), yttrium (Y) and elements having atomic numbers from 58 to 71 inclusive, and δ is a positive number determined from stoichiometry.

In particularly useful multiphasic compositions according to the invention the second phase comprises a mixed conducting oxide characterized as having a perovskite structure represented by
(La_{1-y}Sr_{y})MO_{δ} (IV)
where y is a number from zero to about one; M is selected from the group consisting of iron (Fe), chromium (Cr), cobalt (Co); and combinations thereof, and δ is a positive number determined from stoichiometry.

In accordance with one aspect of the invention the first phase comprises a mixed conducting oxide characterized as having a perovskite structure represented by
(Ca)(Zr₁₋ₓInₓ)O_{δ} (V)
where x is a number from zero to about one; and δ is a positive number determined from stoichiometry. In accordance with another aspect of the invention the first phase comprises a mixed conducting oxide characterized as having a perovskite structure represented by
(Sr)(Ce₁₋ₓYbₓ)O_{δ} (VI)
where x is a number from zero to about one; and δ is a positive number determined from stoichiometry. In accordance with yet another aspect of the invention the first phase comprises a mixed conducting oxide characterized as having a perovskite structure represented by
(Ba)(Ce₁₋ₓNdₓ)O_{δ} (VII)
where x is a number from zero to about one; and δ is a positive number determined from stoichiometry.

In multiphasic compositions according to the invention the first phase beneficially comprises a combination of palladium (Pd) and/or platinum (Pt) and at least one metal selected from the group consisting of cobalt (Co), gold (Au), nickel (Ni), and silver (Ag). In other multiphasic compositions of the invention, the first phase comprises a member selected from the group consisting of palladium (Pd), silver (Ag), and alloys thereof.

In yet another aspect, the invention is a multiphasic solid state membrane for selectively conveying electrons, hydrogen and oxygen between different gaseous mixtures separated by the membrane, comprising: a first phase in the form of an oxide, mixed-metal oxide, metal, or alloy having an ability to selectively convey hydrogen between different gaseous mixtures; and bound to at least the first phase of the multiphasic membrane a second phase in the form of a crystalline mixed metal oxide having an ability to selectively convey at least oxygen ions between different gaseous mixtures, and wherein the first and/or second phase has electronic conductivity. Advantageously, the first phase is distributed throughout the second phase. The first and second phases beneficially comprise two continuous interpenetrating networks. These dense membranes advantageously exhibit ionic and electronic conductivities that are each greater than 0.01 S/cm at 1000° C. in air, under operating conditions.

As stated herein above, materials known as “perovskites” are a class of materials, which have an X-ray identifiable crystalline structure, based upon the structure of the mineral perovskite, CaTiO₃. In its idealized form, the perovskite structure has a cubic lattice in which a unit cell contains metal ions (A) at the corners of the cell, another metal ion (B) in its center and oxygen ions at the centers of each cube face. This cubic lattice is identified as an ABO₃-type structure where A and B represent metal ions. In the idealized form of perovskite structures, generally, it is required that the sum of the valences of A ions and B ions equal 6, as in the model perovskite mineral, CaTiO₃.

There are distinct advantages associated with employing multiphasic systems according to the present invention as a membrane in a chemical reactor. For example, it is known that alkane dehydrogenation equilibrium can be shifted towards the olefin when the reaction is carried out across a membrane capable of transporting hydrogen. If the membrane is also electronically conductive it is possible to drive the reaction by pressure difference (as opposed to being driven by an applied current). A known problem in a reactor of this type is the slow buildup of coke on the alkane side of the reactor. Using a membrane matrix that also conducts oxygen eliminates the coking problem. Oxygen is transported from the airside of the membrane to the alkane side where it reacts with coke precursors as they are formed on the membrane surface. Reaction of the coke precursors with oxygen also provides heat to fuel the endothermic dehydrogenation reaction.

Another use for the oxygen that is transported through such a matrix is to react with hydrogen to produce heat, as is needed in steam reforming. U.S. Pat. No. 6,066,307 in the name of Nitin Ramesh Keskar, Ravi Prasad and Christian Friedrich Gottzmann, described a process for preparing synthesis gas and hydrogen gas using a dual membrane reactor. Their reactor used two membranes, one an oxygen conductor and the other a proton conductor, to produce hydrogen gas and synthesis gas.

U.S. Pat. No. 4,330,633 issued May 18, 1982, in the name of Yoshisato et al., describes a solid electrolyte said to selectively separate oxygen from a gaseous atmosphere having a high oxygen partial pressure into a gaseous atmosphere having a low oxygen partial pressure. Patentees describe the solid electrolytes as composed of a sintered body consisting essentially of an oxide of cobalt, an oxide of at least one metal selected from strontium and lanthanum, and an oxide of at least one metal selected from bismuth and cerium.

U.S. Pat. No. 4,659,448 issued Apr. 21, 1987, in the name of Gordon, describes a process for removal of SO_{X} and NO_{X} from flue gases using a solid state electrochemical ceramic cell. Patentee states that the process requires application of an external electrical potential to electro-catalytically reduce SO_{X} and NO_{X} to elemental sulfur and free nitrogen gas. Oxygen apparently is removed through the solid electrolyte in what amounts to electrolysis.

### BRIEF DESCRIPTION OF THE INVENTION

The term “multiphasic” refers to a material that contains two or more solid phases interspersed without forming a single-phase solution. Useful core material, therefore, includes the multiphasic system which is “multiphasic” because the hydrogen conveying material, the electronically-conductive material and the oxygen ion-conductive material are present as at least two solid phases, such that atoms of the various components of the multi-component solid are, primarily, not intermingled in the same solid phase.

One method for achieving this result incorporates the minority phase into the powder from which the membrane is made by deposition of the metal or metal oxide from a polymer made by polymerizing a chelated metal dispersion in a polymerizable organic monomer or prepolymer. The multiphasic composition advantageously comprises a first phase of a ceramic material and a second phase of a metal or metal oxide bound to a surface of the ceramic material. A second method fabricates the membrane from a mixture of two powders one of which contains a mixture of the two phases

Hydrogen conveying materials useful in multiphasic compositions of the invention include preselected metals and oxide materials. Mechanisms by which metals such as Pd are understood to convey hydrogen includes dissociation of hydrogen molecules into hydrogen atoms on one side of the membrane. The hydrogen atoms are conveyed through the membrane, and recombine on the opposite side to reform hydrogen molecules. Oxide materials such as doped barium cerate are understood to conduct protons not hydrogen atoms. Hydrogen dissociates at one surface of the membrane to form electrons and protons. The electrons and protons are understood to then be transported, co-currently through the membrane, and reassociate on the opposite side to form hydrogen. The co-current flow of protons and electrons is driven by a concentration gradient where a sweep gas is used on the opposite side of the membrane, as shown in U.S. Pat. No. 6,037,514, in the name of James H. White, Michael Schwartz and Anthony F. Sammels.

The metal or metal oxide is chosen from metals, such as silver, palladium, platinum, gold, rhodium, titanium, nickel, ruthenium, tungsten, tantalum, or alloys of two or more of such metals that are stable at membrane operating temperatures. Additionally, suitable high-temperature alloys include inconel, hastelloy, monel, and bucrollol.

In another aspect of the invention, the hydrogen conveying phase is chosen from ceramics, such as praseodymium-indium oxide mixture, niobium-titanium oxide mixture, titanium oxide, nickel oxide, tungsten oxide, tantalum oxide, ceria, zirconia, magnesia, or a mixture thereof. Some ceramic second phases, such as titanium oxide or nickel oxide, can be introduced in the form of oxides, then reduced to metal during the operation under a reduction atmosphere.

Transport of oxygen through solid, gas-impervious materials, without external electrodes, is understood to proceed by conduction of oxygen ions and transport of electrons. One class of materials having an ability to selectively convey oxygen ions and elections between different gaseous mixtures useful in multiphasic compositions of the invention has been described in the literature. See, for example, U.S. Pat. No. 5,306,411 in the name of Terry J. Mazanec, Thomas L. Cable, John G. Frye, Jr. and Wayne R. Kliewer; U.S. Pat. No. 5,702,999, in the name of Terry J. Mazanec and Thomas L. Cable; and U.S. Pat. No. 5,712,220 in the name of Michael Francis Carolan, Paul Nigel Dyer, Stephen Andrew Motika and Patrick Benjamin Alba, which describe suitable mixed oxide perovskites capable of intrinsic conductivity for electrons and oxygen ions in a single phase. A common problem with these mixed conductors is their fragility and low mechanical strength.

The invention disclosed herein is intended to be applicable to mixed metal conducting oxide ceramics encompassed by the formula:
(A_{1-y}A′_{w}A″_{y-w})(B₁₋ₓB′_{z}B″_{x-z})O_{δ} (VIII)
where A, A′ and/or A″ are chosen from the groups I, II, II and the F block lanthanides; and B, B′ and/or B″ are chosen from the D block transition metals according to the Periodic Table of the Elements adopted by the IUPAC; x and y are each independently selected numbers from zero to about one, and w is a number zero to y, and z is a number zero to x; and δ is a number determined from stoichiometry that renders the compound charge neutral. Typically, A, A′ and/or A″ of this ceramic class is a preselected Group II metal consisting of magnesium, calcium, strontium and barium. Useful lanthanide-containing metal oxide compositions also containing calcium or strontium are described in U.S. Pat. No. 5,817,597, in the name of Michael Francis Carolan, Paul Nigel Dyer and Stephen Andrew Motika.

Particularly useful mixed conducting oxides are encompassed by the formula
(A_{1-y}A′_{y})(B₁₋ₓB′_{z}B″_{x-z})O_{δ} (IX)
where A is a lanthanide element, Y, or mixture thereof, A′ is one or more alkaline earth metal; B is iron (Fe); B′ is chromium (Cr), titanium (Ti), or mixture thereof and B″ is manganese (Mn), cobalt (Co), vanadium (V), nickel (Ni), copper (Cu) or mixture thereof; and x and y are each independently selectered numbers from zero to about one, and z is a number zero to x; and δ is a number determined from stoichiometry that renders the compound charge neutral.

The multiphasic compositions of this invention advantageously comprise ceramic structures represented by the formula:
(A_{1-y}A′_{y})(B₁₋ₓB′ₓ)O_{δ} (X)
where A is a lanthanide element; A′ is a suitable lanthanide element dopant; B is selected from the group consisting of titanium (Ti), vanadium (V), chromium (Cr), manganese (Mn), iron (Fe), cobalt (Co), nickel (Ni), zinc (Zn) and mixture thereof; B′ is copper (Cu); y is a number from about 0.4 to 0.9; x is a number from 0.1 to about 0.9; and δ is a number determined from stoichiometry that renders the compound charge neutral.

In another aspect the multiphasic compositions of this invention advantageously comprise ceramic structures represented by the formula:
(La_{1-y}Sr_{y})(Cu₁₋ₓGₓ)O_{δ} (XI)
where G is selected from the group consisting of iron (Fe) and cobalt (Co) and mixture thereof; y is a number from about 0.1 to 0.9; x is a number from 0.1 to about 0.9; and δ is a number determined from stoichiometry that renders the compound charge neutral.

For example, see the description of cubic perovskite ceramic oxygen ion transport materials in U.S. Pat. No. 6,235,187 in the name of Harlan U. Anderson, Vincent Sprenkle, Ingeborg Kaus, and Chieh-Cheng Chen. This material, in the form of a membrane selectively transports oxygen ions therethrough at a relatively low temperature, with a flux detected at about 600° C. This enables useful oxygen separation to be carried out at lower temperatures than convention separators that frequently have operating temperatures in excess of 900° C. Mechanical stability may be enhanced by the addition of a second phase to the ceramic. However, Anderson et al. states that when B includes cobalt in an amount greater than 0.1, the included iron content should be less than 0.05, because an increase in iron substitution decreases oxygen ion conductivity of the material. Preferably, iron is present in no more than impurity levels.

U.S. Pat. No. 5,911,860, in the name of Chieh Cheng Chen and Ravi Prasad also describes a useful oxygen ion transport membrane material having at least two phases wherein one of the phases comprises an oxygen ion single conductive material and another constituent which is physically distinct and which enhances the mechanical properties and/or sintering behavior of the material.

A particularly useful phase for conveying oxygen ions according to the invention is represented by the formula
(La_{0.2}Sr_{0.8})(Co_{0.9}Cu_{0.1})O_{δ} (XII)

Another class of oxygen ion-conducting materials or phases are formed between oxides containing divalent and trivalent cations such as calcium oxide, scandium oxide, yttrium oxide, lanthanum oxide, and the like, with oxides containing tetravalent cations such as zirconia, thoria, and ceria. Some of the known solid oxide transfer materials of this variety include Y₂O₃-stabilized ZrO₂, CaO-stabilized ZrO₂, Sc₂O₃-stabilized ZrO₂, Y₂O₃-stabilized Bi₂O₃, CaO-stabilized CeO₂, Y₂O₃-stabilized CeO₂, Gd₂O₃-stabilized CeO₂, ThO₂, Y₂O₃-stabilized ThO₂, or ZrO₂, ThO₂, CeO₂ Bi₂O₃, or HfO₂ stabilized by addition of any one of lanthanide oxides or alkaline earth metal oxides. Other oxides that have demonstrated oxygen ion-conveying ability can be used in the multiphasic materials of the present invention.

Commonly assigned, U.S. Pat. No. 6,332,964, in the name of Chieh Cheng Chen, Bavi Prasad, Terry J. Mazanec, and Charles J. Besecker, also describes forming a membrane material capable of conducting oxygen ions and electrons. The solid electrolyte ion transport membrane is described, as comprising at least two phases wherein one of the phases comprises an oxygen ion single conductive material. The other phase comprises an electronically conductive metal or metal oxide conducting phase is present in a low volume percentage. This makes it possible to use materials that conduct oxygen ions, but not electrons, by using another phase that provides electron conduction. Enhanced mechanical properties are achieved as compared with those provided by a single mixed conductor alone. In accordance with the invention, at least one phase in these materials is also capable of hydrogen transport, advantageously in addition to electron conduction. We believe that this is the first reported demonstrated example of a single membrane capable of transporting oxygen, hydrogen, and electrons.

In accordance with one aspect of the invention, a solid electrolyte ion transport membrane comprises a first phase, made from granulated or matrix material, which conducts at least one type of ion (typically oxygen ions) and another phase, physically distinct from the matrix material, which comprises a metal or metal oxide. This phase is incorporated onto the surface of the granulated or matrix material, for example by means of the dispersion described in U.S. Pat. No. 6,332,964. The second phase is present in a manner, which increases the homogeneity of the phases within the matrix material, thereby enhancing the mechanical and/or catalytic properties of the matrix material while minimizing the amount of constituent material needed and also decreases the percolation threshold for the second phase.

U.S. Pat. No. 6,187,157 in the name of Chieh Cheng Chen and Ravi Prasad also describes a useful method of forming a membrane material having at least two phases wherein one of the phases comprises an oxygen ion single conductive material, or a mixed conductor. The other phase comprises an electronically-conductive metal or metal oxide that is incorporated into the membrane by deposition of the metal or metal oxide from a polymer made by polymerizing a chelated metal dispersion in a polymerizable organic monomer or prepolymer. This composition advantageously comprises a first phase of a ceramic material and a second phase of a metal or metal oxide bound to a surface of the ceramic material. This composition is advantageously prepared in an in-situ fashion before fabricating the membrane matrix. In another alternative method, a preformed ceramic matrix is surface-coated with a metal or metal oxide.

A particularly advantageous multi-phase, composite material is comprised of a first mixed conductor phase, such as a perovskite and a second phase of a metal or metal oxide distributed uniformly on the surface of the first mixed conductor phase. This second phase tends to prevent microcracking of the membrane, eliminate special atmospheric control during processing and operation, and improve the mechanical properties, thermal cyclability, atmosphere cyclability and/or surface exchange rates over that of the mixed conductor phase alone. This second phase is suitably incorporated onto the surface of the mixed conductor granules using the above-described starting dispersion. The resulting dual-phase membrane exhibits improved mechanical properties, and preferably also exhibits improved catalytic properties, without sacrificing its oxygen transport performance. Further, this second phase can relieve compositional and other stresses generated during sintering, inhibit the propagation of microcracks in the mixed conductor phase and hence improve the mechanical properties (especially tensile strength) significantly. Since atmosphere control can be eliminated during sintering, manufacture is easier and less costly. The ability to eliminate atmosphere control during thermal cycling makes it substantially easier to deploy the membranes in practical systems which are more robust and better withstand transitional stresses created by temperature or gas composition variations.

Multiphasic compositions of the invention comprising two or more phases bound to one another wherein at least one of the bound phases demonstrates an ability to selectively convey hydrogen, another phase demonstrates an ability to selectively convey oxygen ions between different gaseous mixtures, and one or more of the phases demonstrates electronic conductivity. The invention contemplates use of solid materials that convey hydrogen between different gaseous mixtures by any mechanism.

Other alternative ways to practice the invention include using physically continuous non-electronically-conductive second phases, such as glass, asbestos, ceria, zirconia or magnesia fibers or wires, or flakes of a material such as mica, to reinforce the ion transport matrix. The continuous second phase can be distributed substantially uniformly in the ion transport matrix, provide structural reinforcement and enhance the mechanical properties of the ion transport membrane. The fibers typically have a diameter less than one mm, preferably less than 0.1 mm, more preferably less than 0.01 mm and most preferably less than one micron. The aspect ratio (length to diameter) typically is greater than 10, preferably greater than 100, and more preferably greater than 1000.

Generally suitable ion transport membrane materials include ionic only and mixed conductors that can transport oxygen ions. If made according to the present invention, the mixed conductor phase may transport both oxygen ions and electrons independent of the presence of the hydrogen conveying and/or electronic conducting phase. Examples of mixed conducting solid electrolytes useful in this invention are provided herein, but this invention is not limited solely to these material compositions. Dense matrix materials other than those comprised only of mixed conductors are also contemplated by this invention.

The following examples will serve to illustrate certain specific embodiments of the herein-disclosed invention. These examples should not, however, be construed as limiting the scope of the novel invention, as there are many variations which may be made thereon without departing from the spirit of the disclosed invention, as those of skill in the art will recognize.

### EXAMPLES OF THE INVENTION

The following examples will serve to illustrate certain specific embodiments of the herein-disclosed invention. These Examples should not, however, be construed as limiting the scope of the novel invention as there are many variations which may be may thereon without departing from the spirit of the disclosed invention, as those skilled in the art will recognize.

General

The membrane comprises a first phase, made from granulated material, which conducts oxygen ions. The second phase, which is physically distinct from the first phase, comprises a granulated material capable of transporting hydrogen. At least one of the phases is also an electron conductor. The second phase is present in a manner that increases the homogeneity of the phases, thereby enhancing the mechanical properties of the mixture.

### Example 1

A multiphasic, solid state, hydrogen, electrons and oxygen transport membrane was fabricated from cerium-stabilized zirconia and palladium (CEZ/Pd) as follows:

a) 5.3 g of cerium stabilized zirconia, obtained from American. Vermiculite Corporation (CEZ-10SD), was mixed with 12.06 g of palladium flake, obtained from Degussa Corporation, for 30 minutes in a mortar and pestle.

b) Approximately 5 g of the mixture was loaded into a cylindrical dye (1.25 inch diameter) and compressed to 26,000 lbs. using a Carver Laboratory Press (Model #3365).

c) The CEZ/Pd disc was sintered by heating in air to 1300° C. and holding at that temperature for 4 hours.

The sintered membrane was placed between two gold rings and heated to 900° C. at 0.5° C./minute. The sintered membrane was sealed with gold rings into the two-zone disc reactor.

Hydrogen and oxygen permeabilities were measured at 0.1-0.33 sccm/cm²/min and 0.01 sccm/cm²/min, respectively. The trans-membrane oxygen to hydrogen ratio was measured to be 0.03-0.1 and the ceramic to metal ratio was 2.45.

The reactor was heated to 800° C. under nitrogen. One side of the reactor was exposed to air and the other side exposed to ethane and steam (ethane and steam in a 1:1 weight ratio). The product from the hydrocarbon side was analyzed by gas chromatography. The carbon weight percent composition of the product is presented in Table 1.

The selectivity for ethylene was 88 percent. The ethylene production rate was 28 mL/cm²/min. This membrane was studied for 600 hours in ethane/steam service and was stable.

### Example 2

A multiphasic, solid state, hydrogen, electrons and oxygen transport membrane was fabricated from cerium gadolinium oxide and silver/palladium (CGO/(Ag/Pd)) as follows:

a) A batch of cerium gadolinium oxide powder, obtained from Rhodia, was heated in air to 1000° C. and held at that temperature for one hour. The powder was then sifted with a 60-mesh filter.

b) 1.93 g of the sifted cerium gadolinium oxide powder was mixed with 2.13 g of palladium/silver (70/30) flake, obtained from Degussa Corporation, for 30 minutes in a mortar and pestle.

c) Approximately 6 g of the mixture was loaded into a cylindrical dye (1.25 inch diameter) and compressed to 26,000 lbs. using a Carver Laboratory Press (Model #3365).

d) The CGO/(Ag/Pd) disc was sintered by heating in air to 1300° C. and holding at that temperature for 4 hours.

Hydrogen and oxygen permeabilities were measured at 12.2 sccm/cm²/min and 0.34 sccm/cm²/min, respectively. The trans-membrane oxygen to hydrogen ratio was measured to be 0.03 and the ceramic to metal ratio was 1.50 (2.14 for active metal).

The reactor was heated to 800° C. under nitrogen. One side of the reactor was exposed to air and the other side exposed to ethane and steam (ethane and steam in a 1:1 weight ratio). The product from the hydrocarbon side was analyzed by gas chromatography. The carbon weight percent composition of the product is presented in Table 1.

The selectivity for ethylene was 82 percent. The ethylene production rate was 28 mL/cm2/min. The material with the higher trans-membrane oxygen to hydrogen flux had lower conversion but higher selectivity to ethylene. The ability to control carbon monoxide, methane, acetylene, and heavier hydrocarbon production with this ratio is an economically valuable attribute.

TABLE 1
Selectivity pattern of ethane from membrane reactors

Selectivity

| MEBRANE | Example 1 | Example 2 |
|---|---|---|
| Conversion | 75.6% | 88.2% |
| Temperature | 878° C. | 885° C. |
| Material | CEZ/Pd | CGO/(Ag/Pd) |
| Sweep | Air | Air |
| CO | 0 | 0.5 |
| Methane | 5.2 | 8.8 |
| Ethane | | |
| Ethylene | 88.15 | 81.8 |
| Acetylene | 1.88 | 2.57 |
| Propane | 0.20 | |
| Propylene | 1.06 | 1.12 |
| Propadiene | 3.51 | 3.19 |
| Pentenes | | 2.02 |
| O2/H2 flux | 0.1 | 0.03 |
| C2 = production rate | 28 | 28 |
| (mL/cm²/min) | | |

### Example 3

In experiments 3-A and 3-B, the yields from propane dehydrogenation were roughly the same. Beneficially, the total olefin yields significantly exceed the olefins yields obtained from state of the art dehydrogenation and pyrolysis reactors.

TABLE 2
Selectivity pattern of propane from membrane reactors

Selectivity

| EXAMPLE 3 | 3-A | 3-B |
|---|---|---|
| Conversion | 95.0% | 94.4% |
| Temperature | 870° C. | 875° C. |
| Material | CGO/(Ag/Pd) | CGO/(Ag/Pd) |
| CO | 0.5 | 0.6 |
| Methane | 27.6 | 27 |
| Ethane | 2.3 | 2.0 |
| Ethylene | 52.83 | 51.6 |
| Acetylene | 2.26 | 2.7 |
| Propane | | |
| Propylene | 10.7 | 10.7 |
| Propadiene | 3.69 | 3.46 |
| Butenes | 0.12 | 0.6 |
| Pentenes | | 1.34 |
| O2/H2 flux | 0.03 | 0.06 |
| C2 = production rate | 27 | 27 |
| (mL/cm²/min) | | |

In experiments 3-C and 3-D, the ethane and propane feedstreams were replaced with other hydrocarbons, in particular with iso-butane and debutanized natural gasoline (DNG), a liquid cut consisting of hydrocarbons with 5 to 7 carbons and no olefins. Table 3 presents information for iso-butane fed to a membrane reactor whose perovskite phase had the composition represented by Ce_{0.8}Gd_{0.2}O_{δ}.

TABLE 3
Selectivity of iso-butane from a membrane reactor

Selectivity

| EXAMPLE 3 | 3-C | 3-D |
|---|---|---|
| Conversion | 68.3% | 80.3% |
| Temperature | 830° C. | 850° C. |
| Material | CGO/Pd | CGO/Pd |
| CO | 0.5 | 0.5 |
| Methane | 21.1 | 22.5 |
| Ethane | 1.3 | 1.6 |
| Ethylene | 10.1 | 12.9 |
| Acetylene | 0.8 | 1.2 |
| Propane | | |
| Propylene | 33.6 | 29.9 |
| Propadiene | 0.44 | 0.63 |
| 1,3-Butadiene | 2.16 | 8.09 |
| 1-Butene | 3.14 | 2.84 |
| Isobutylene | 25.7 | 18.92 |
| Pentenes | 1.16 | 0.92 |
| O2/H2 flux | 0.03 | 0.06 |
| C2 = production rate | 8 | 8 |
| (mL/cm²/min) | | |

In Example 1 the trans-membrane oxygen to hydrogen flux ratio was 0.1 with a ceramic to metal ratio of 2.45. In Examples 3-C and 3-D the trans-membrane oxygen to hydrogen flux ratio was 0.03 with a ceramic to metal ratio of 1.5. These Examples illustrate that the composition can be used to adjust the trans-membrane oxygen to hydrogen flux ratio.

That which is claimed is:

1. A multiphasic composition which in the form of a solid state membrane demonstrates an ability to selectively convey electrons, hydrogen and oxygen between different gaseous mixtures, the multiphasic composition comprising two or more phases bound to one another wherein at least one of the bound phases demonstrates an ability to selectively convey hydrogen, another phase demonstrates an ability to selectively convey oxygen ions between different gaseous mixtures, and one or more of the phases demonstrates electronic conductivity.

2. The multiphasic composition of claim 1 which in the form of a solid state membrane demonstrates an ability to simultaneously convey a flux of hydrogen and, counter-current thereto, a flux of oxygen.

3. A dense ceramic membrane permeable to hydrogen, oxygen and demonstrates electronic conductivity comprising the multiphasic composition according to claim 1.

4. The membrane of claim 3 which further comprises a continuous, dense, fine-grained, agglomerating agent comprising material according to one of the two bound phases.

5. The membrane of claim 4 wherein the agent comprises a mixed metal oxide that demonstrates an ability to selectively convey oxygen ions, and wherein one of the bound phases comprises a metal, alloy or mixed metal oxide that demonstrates electronic conductivity.

6. A transport membrane having an ability to selectively convey electrons, hydrogen and oxygen between different gaseous mixtures, the membrane comprising: a non-homogenous, multiphasic solid containing a first phase comprising a metal, alloy or mixed-metal oxide, and a second phase comprising a mixed metal oxide ceramic, wherein the first and second phases are bound to one another and distributed, in a physically distinguishable form, throughout the continuous, fine-grained, second phase.

7. The membrane according to claim 6 wherein the first phase comprises at least one metal selected from the group consisting of silver, palladium, platinum, gold, rhodium, titanium, nickel, ruthenium, tungsten, and tantalum.

8. The membrane according to claim 6 wherein the first phase comprises a ceramic selected from the group consisting of a praseodymium-indium oxide mixture, niobium-titanium oxide mixture, titanium oxide, nickel oxide, tungsten oxide, tantalum oxide, ceria, zirconia, magnesia, or a mixture thereof.

9. The membrane according to claim 6 wherein the second phase comprises a mixed conducting oxide composition represented by
(A_{1-y}A′_{y})(B₁₋ₓB′_{z}B″_{x-z})O_{δ}
where A is a lanthanide element, yttrium (Y), or mixture thereof, A′ is one or more alkaline earth metal; B is iron (Fe); B′ is chromium (Cr), titanium (Ti), or mixture thereof and B″ is manganese (Mn), cobalt (Co), vanadium (V), nickel (Ni), copper (Cu) or mixture thereof; and x and y are each independently selected numbers from zero to about one, and z is a number zero to x; and δ is a number determined from stoichiometry that renders the compound charge neutral.

10. The membrane according to claim 6 wherein the second phase comprises a mixed conducting cerium oxide composition represented by
M′CeO_{δ}
where M′ is selected from the group consisting of yttrium (Y) and elements having atomic numbers from 58 to 71 inclusive, and δ is a positive number determined from stoichiometry.

11. The membrane according to claim 6 wherein the second phase comprises a mixed conducting zirconium oxide composition represented by
M″ZrO_{δ}
where M″ is selected from the group consisting of calcium (Ca), yttrium (Y) and elements having atomic numbers from 58 to 71 inclusive, and δ is a positive number determined from stoichiometry.

12. The membrane according to claim 6 wherein the second phase comprises a mixed conducting oxide characterized as having a perovskite structure represented by
(La_{1-y}Sr_{y})MO_{δ}
where y is a number from zero to about one; M is selected from the group consisting of iron (Fe), chromium (Cr), cobalt (Co); and combinations thereof and δ is a positive number determined from stoichiometry.

13. The membrane according to claim 6 wherein the first phase comprises a mixed conducting oxide characterized as having a perovskite structure represented by
(Ca)(Zr₁₋ₓInₓ)O_{δ}
where x is a number from zero to about one; and δ is a positive number determined from stoichiometry.

14. The membrane according to claim 6 wherein the first phase comprises a mixed conducting oxide characterized as having a perovskite structure represented by
(Sr)(Ce₁₋ₓYbₓ)O_{δ}
where x is a number from zero to about one; and δ is a positive number determined from stoichiometry.

15. The membrane according to claim 6 wherein the first phase comprises a mixed conducting oxide characterized as having a perovskite structure represented by
(Ba)(Ce₁₋ₓNdₓ)O_{δ}
where x is a number from zero to about one; and δ is a positive number determined from stoichiometry.

16. The membrane according to claim 6 wherein the first phase comprises a combination of palladium and/or platinum and at least one metal selected from the group consisting of cobalt (Co), gold (Au), nickel (Ni), and silver (Ag).

17. The membrane according to claim 6 wherein the first phase comprises a member selected from the group consisting of palladium (Pd), silver (Ag), and alloys thereof.

18. A multiphasic solid state membrane for selectively conveying electrons, hydrogen and oxygen between different gaseous mixtures separated by the membrane, comprising: a first phase in the form of an oxide, mixed-metal oxide, metal, or alloy having an ability to selectively convey hydrogen between different gaseous mixtures; and bound to at least the first phase of the multiphasic membrane a second phase in the form of a crystalline mixed metal oxide having an ability to selectively convey at least oxygen ions between different gaseous mixtures, and wherein the first and/or second phase has electronic conductivity.

19. The membrane according of claim 18 wherein the first phase is distributed throughout the second phase.

20. The membrane according of claim 18 wherein the first and second phases comprise two continuous interpenetrating networks.

21. The membrane according of claim 18 under operating conditions exhibits ionic and electronic conductivities that are each greater than 0.01 S/cm at 1000° C. in air.
